(19) United States
(12) Patent Application Publication
(10) Pub. No.: US 2019/0047236 A1
(43) Pub. Date: Feb. 14, 2019

(54) DESIGN AND FABRICATION OF A MULTILAYER THREE-DIMENSIONAL COMPOSITE MEMBRANE

(71) Applicants: Eduardo Antonio Julian Ruiz, Montreal (CA); Alexandre Ferreira Benevides, Laval (CA)

(72) Inventors: Eduardo Antonio Julian Ruiz, Montreal (CA); Alexandre Ferreira Benevides, Laval (CA)

(21) Appl. No.: 15/676,381

(22) Filed: Aug. 14, 2017

(51) Int. Cl. B29C 70/44; B29C 70/34; B32B 7/12; B32B 15/06; B32B 25/10; B32B 27/32; B32B 33/00; B32B 37/10; B32B 37/18

(52) U.S. Cl. CPC B29C 70/44; B32B 2307/726; B32B 7/12; B32B 15/06; B32B 25/10; B32B 27/322; B32B 33/00; B32B 37/1018; B32B 37/18; B32B 2255/10; B32B 2255/205; B32B 2262/101; B32B 2262/106; B32B 2262/0261; B32B 2305/076; B32B 2309/68; B29C 2791/006; B29C 70/342

(57) ABSTRACT

The present disclosure relates to a multilayer three-dimensional and possibly segmented flexible membrane used to manufacture composite components, and in particular, to the multiple constitutive components of the membrane including a layer of partially curable material and the process of manufacture based on pressure and temperature control. A multilayer membrane specification and a process of manufacture of such multilayer membrane is provided. The multilayer membrane may include a series of fibrous reinforcements to control the rigidity of the membrane, a porous layer in drainage applications and an external layer to act as a protective surface coating. The assembly is placed on a mold providing the geometry of the component to be molded and then sealed with a plastic vacuum bag prior to cure the assembly on an oven at high temperature following a predesigned curing cycle.

The present disclosure relates to a multilayer three-dimensional and possibly segmented flexible membrane used to manufacture composite components, and in particular, to the multiple constitutive components of the membrane including a layer of partially curable material and the process of manufacture based on pressure and temperature control.

### BACKGROUND

In many industrial applications, composite materials provide unique mechanical properties, especially high strength and stiffness in lightweight components. It is also possible to custom tailor the properties of the components via the choice of reinforcing materials, resins, layup, fiber volume fractions, and/or using specified compaction or compression loads during fabrication and/or specific manufacturing processes, etc.

In resin molding processes, a mold having an interior cavity that defines the shape of the to-be-molded component is provided. The mold is sealed with a flexible membrane that acts as a counter-mold. Vacuum is pulled within the mold cavity formed by the mold and the flexible membrane. A structural reinforcement (or prepreg) material may be placed within the mold cavity prior to infusing or injecting the resin. The flexible membrane allows consolidation of the reinforcing fibers and liquid resin due to the pressure difference between the exterior of the mold (atmospheric pressure) and the interior of the mold (vacuum).

### SUMMARY

According to a first aspect, a multilayer membrane and a process of manufacture of such multilayer membrane is provided. The multilayer membrane may include a series of fibrous reinforcements to control the rigidity of the membrane, a porous layer in drainage applications and an external layer to act as a protective surface coating. To locally increase the rigidity of the membrane, metallic sheets and/or wires can be embedded within the multilayer membrane or glued on its exterior surfaces. The multilayer membrane may be protected with a metallic coating with non-adhesive properties to protect the membrane over chemical degradation due to the high temperature cure of the polymer resin. The multilayer membrane improves durability and geometrical stability at high temperature due to the controlled rigidity. The anti-adhesive properties of the multilayer membrane facilitate demolding of the composite component and improve its durability. The metallic inserts allow controlling the geometry of the molded composite components.

According to another aspect, a process to mold the multilayer membrane is provided. The multilayer membrane is composed of several layers of uncured polymer, dry reinforcing fibers (or prepreg), a porous plastic film and sheets and/or wires of metallic inserts. The assembly is placed on a mold providing the geometry of the component to be molded and then sealed with a plastic vacuum bag prior to cure the assembly on an oven at high temperature following a predesigned curing cycle. The molding cycle provided includes the manufacturing of the multilayer membrane in the form of closed bladders.

The following general description and details are given as examples of the invention, but this is not restrictive.

### DESCRIPTION OF DRAWINGS

The accompanying drawings constitute part of this specification and illustrate several embodiments of the invention. Together with the following description, the purpose of these illustrations is to explain the principles of the disclosed apparatus and method.

FIG. 1 shows a typical configuration for molding composite components with a flexible membrane.

FIG. 2 gives a view of the multilayer membrane to be manufactured on a rigid mold having the shape of the composite component to be molded.

FIG. 3 shows an example of the molding cycle used to manufacture the multilayer membrane.

FIG. 4 displays schematics of a multilayer membrane containing metallic sheets or wires and a metallic coating.

FIG. 5 describes an example of manufacture of a multilayer membrane in two steps in the case of a closed bladder.

FIG. 6 describes an example of manufacture of a multilayer membrane in the form of an axisymmetric bladder.

### DETAILED DESCRIPTION

Aspects of the apparatus and method presented herein are described in the context of a composite molding process. However, the invention is not limited to composite molding (unless such limitation is mentioned explicitly).

A composite molding process requires a pressure differential across the mold cavity to consolidate the material, i.e., impregnate the reinforcing fibers with liquid resin. Composite molding processes may include one or two rigid molds to compress or consolidate the molded component. In the case of a rigid mold, a plastic bag or flexible membrane is used as counter mold, under which vacuum is pulled (between the rigid mold and the flexible membrane). Thus, the atmospheric pressure is applied on the plastic bag or flexible membrane to consolidate the composite component. A typical molding process to manufacture components, particularly composite components, is described herein.

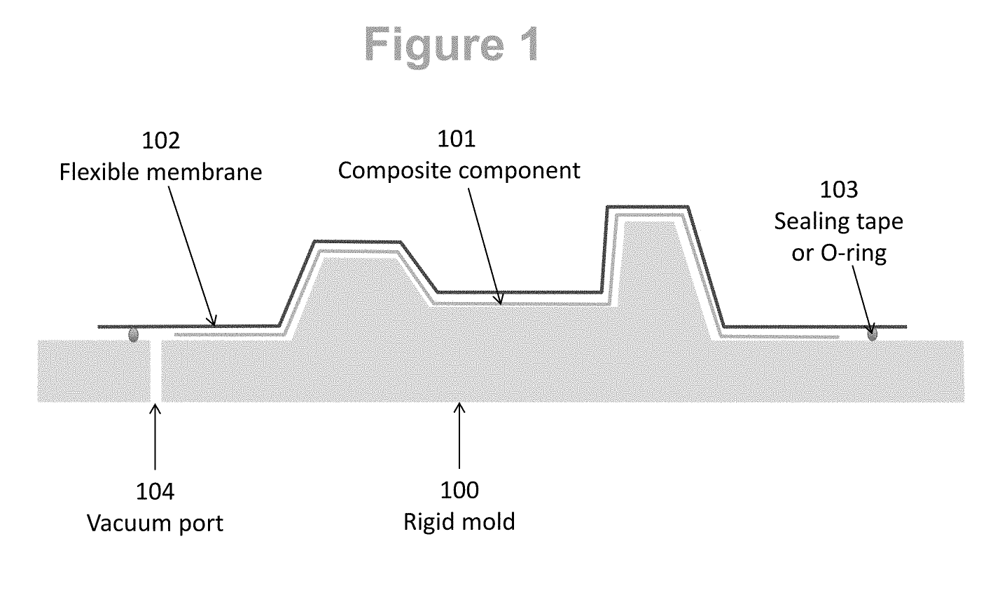

FIG. 1 shows a rigid mold 100, providing the geometry of the composite component to be molded. A composite component 101 is placed on the surface of the rigid mold. The composite component can be made of a prepreg material or dry reinforcing fibers, i.e., typically glass, carbon or kevlar fibers. In the case of dry reinforcing fibers, a liquid resin is infused to impregnate the dry fibers. Typically, the top element forming the mold cavity may be a vacuum bag or flexible membrane 102. The vacuum bag or flexible membrane 102 is vacuum sealed on the periphery of the mold 100 by a sealing tape or O-ring seals 103. A vacuum port 104 is provided to pull vacuum inside the mold cavity. When vacuum is applied, the vacuum bag or flexible membrane deforms, takes the shape of the rigid mold and consolidates the composite component.

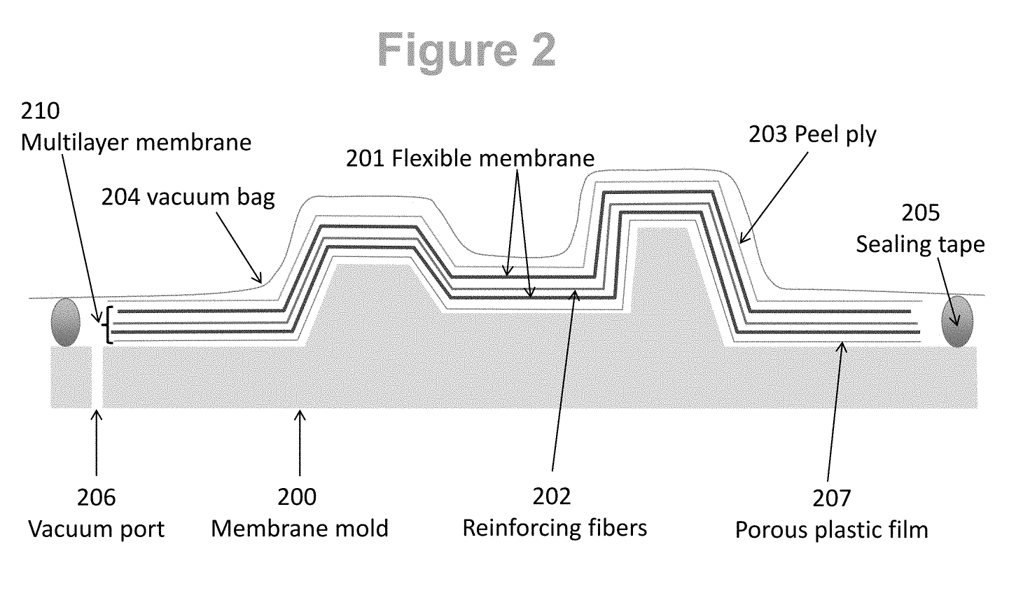

FIG. 2 shows the multilayer membrane 210 configured to be manufactured on a rigid mold 200. The rigid mold 200 follows the geometry of the molded composite component to which the multilayer membrane must be conformed during molding of the composite component. Partially cured rubber sheets 201 (usually called b-stage rubber sheets) are examples of typical materials used as flexible layer in the membrane. A key feature of the material of the flexible layer is to be partially curable. The flexible layer is placed on the surface of the rigid mold. Reinforcing fibers 202 are also placed between the partially cured rubber sheets 201.

Reinforcing fibers 202 are typically glass, polyester or any other kind of fibers. A release film 203, typically a Teflon peel ply, is placed on top of the multilayer membrane 210. The purpose of the release film 203 is to avoid bonding of the flexible layer to the vacuum bag 204 and distribute vacuum over the entire surface of the multilayer membrane 210. The vacuum bag 204 is sealed to the rigid mold 200 by a sealing tape 205 placed on the periphery of the rigid mold 200. A vacuum port 206 is provided on the rigid mold 200 to pull vacuum between the vacuum bag 204 and the rigid mold 200.

Rubber sheets 201 are typically made of silicone rubber partially cured on b-stage. Rubber sheets may be made of natural rubber, synthetic rubber or a combination thereof. Partially cured rubber sheets 201 and reinforcing fibers 202 can also be a prepreg material, i.e., the reinforcing fibers are pre-impregnated with partially cured rubber prior to its use on the rigid mold 200. The combination of different reinforcing fibers 202, partially cured rubber sheets 201 of different properties (typically 50 to 70 Shore “A”) and a given combination of layers of fibers and rubber, are the parameters used to optimize the rigidity of the multilayer membrane 210. An optimized membrane possesses enough rigidity to hold the shape of the composite component at high temperature while being flexible enough to ensure consolidation of the composite component under vacuum.

A porous plastic film 207 may also be provided between the rigid mold 200 and the first rubber membrane 201. The plastic film 207 embedded into the multilayer membrane 210 acts as a surface coating with anti-adhesion properties, which provides durability to the multilayer membrane 210 over a longer number of molding cycles. The plastic film 207 is typically a Teflon or nylon porous film with pore size of 10 to 50 microns and thickness of 50 to 200 microns. The plastic film 207 is impregnated by the rubber membrane 201 during the fabrication of the multilayer membrane 210 as a result of the liquid rubber flowing through the open pores of the plastic film 207.

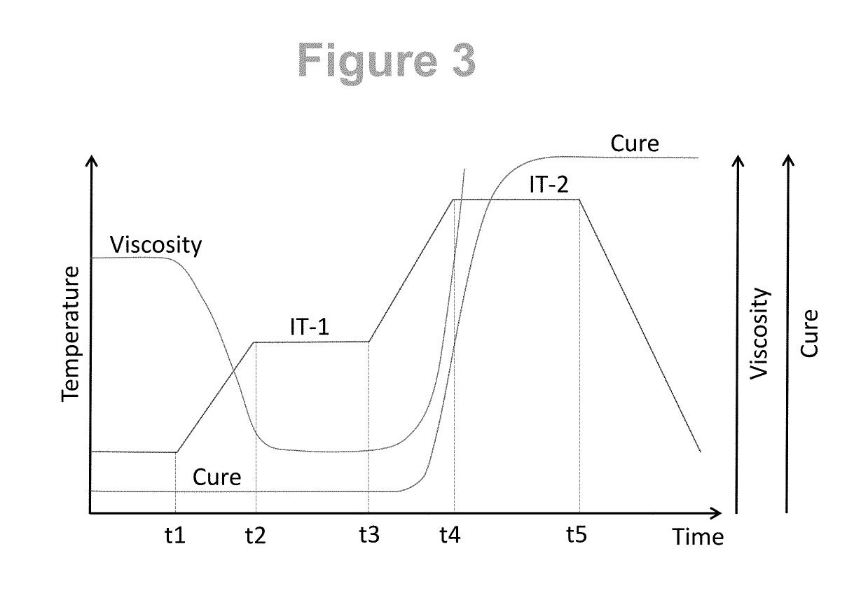

FIG. 3 shows a typical cure cycle to manufacture the multilayer membrane 210. The mold assembly of FIG. 2 is placed inside an oven initially at room temperature. First, vacuum is applied to the mold assembly through the vacuum port 206. Then, the mold assembly is heated to a first isothermal temperature IT-1, typically between 210 and 3000 F. Once the mold assembly reaches the first isothermal temperature IT-1 at time t2, an isothermal dwell is maintained up to time t3. During this first isotherm, the viscosity of the partially cured rubber decreases until a minimum value is reached, typically between 10,000 and 50,000 Pa·s. At this point, the vacuum pressure helps consolidate the multilayer membrane allowing the rubber to penetrate the reinforcing fibers as well as the porous plastic film. Once consolidated, the temperature is increased to a second isotherm IT-2 (typically between 320 and 4000 F.), and maintained for a given dwell from time t4 to t5. During this second isotherm IT-2, the rubber vulcanizes (cures) under vacuum pressure and temperature. The viscosity increases to infinity and the rubber cures up to a maximum degree of cure. Once fully cured (t5), the temperature is decreased to room temperature and the multilayer membrane is demolded.

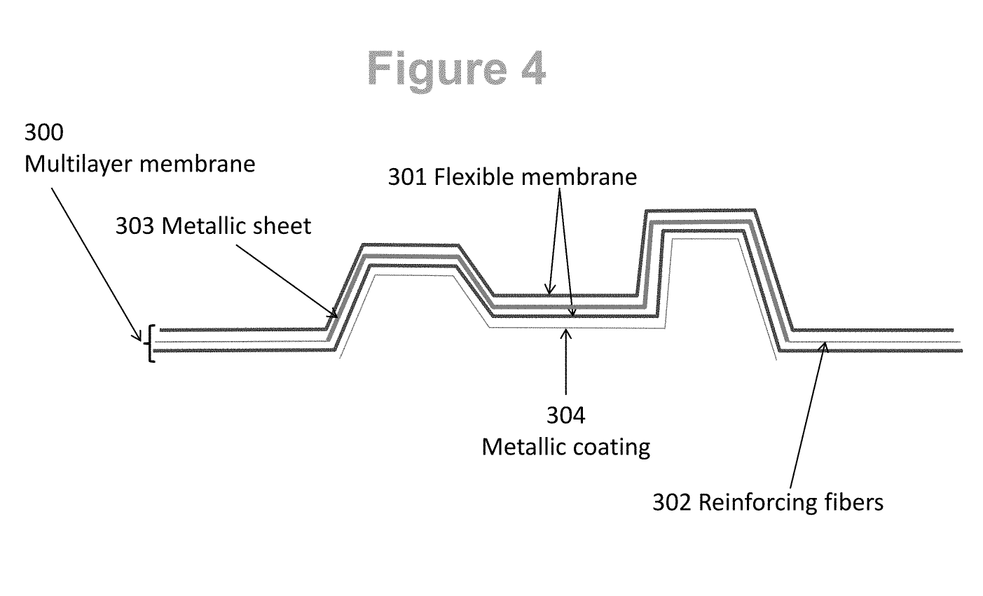

FIG. 4 shows an assembly of a multilayer membrane 300 composed of rubber sheets 301, reinforcing fibers 302 and metallic inserts 303. In this particular embodiment, a metallic sheet 303 is provided to locally increase the rigidity of the multilayer membrane 300. The metallic sheets 303 are molded within the rubber membrane as presented in FIG. 2 and FIG. 3. The metallic sheets 303 can be of planar shape or may have the shape of the composite component to be molded. Reinforcing fibers 302 are still used on the periphery of the multilayer membrane 300 to provide flexibility and durability.

After molding the multilayer membrane 300, it can be locally treated with a metallic coating 304, typically a chrome of nickel based coating. The local coating 304 is used to improve the surface finish of the molded composite component while reducing adhesion to the multilayer membrane, thus improving the durability of the multilayer membrane. Due to the poor adhesion of metallic coatings to rubber, the rigidity of the multilayer membrane can be locally increased in the region where the metallic coating 304 is applied. This can be done by embedding the metallic sheets or grid 303 into the multilayer membrane 300.

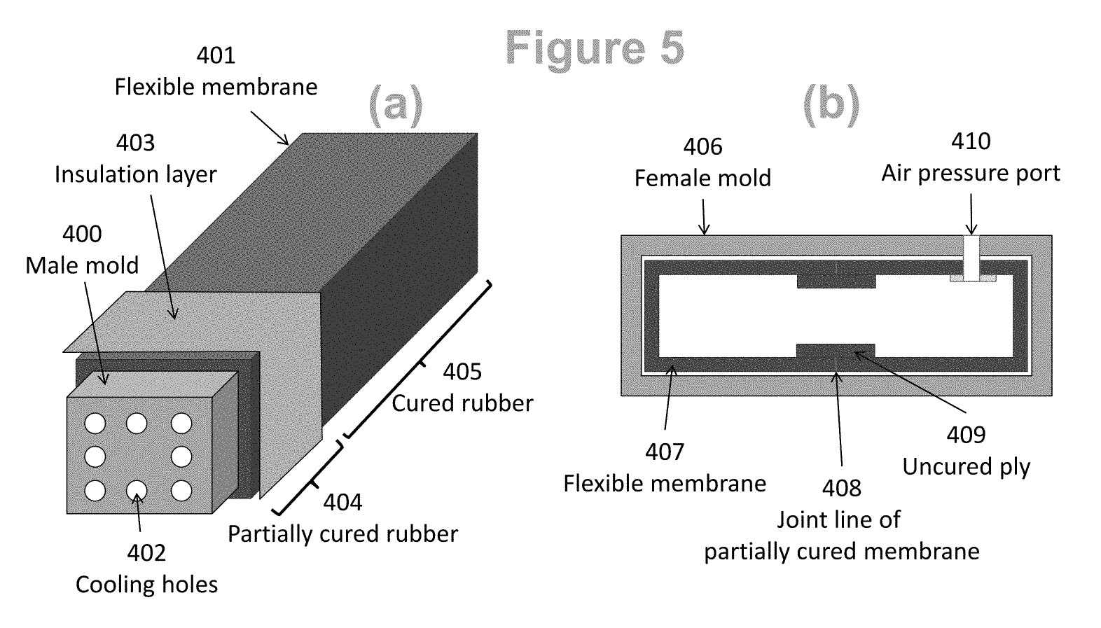

FIG. 5a shows the manufacturing of a multilayer membrane 401 in a series of steps. First, a male mold 400 (or mandrel) is used to drape the multilayer membrane 401 following the descriptions of FIG. 2 and FIG. 3. In this particular case, the multilayer membrane 401 will be fully cured in one region 405 while only partially cured on another region 404. In order to partially cure the multilayer membrane 401, the mandrel 400 is provided with a series of cooling holes 402. During manufacture, a cooling fluid is circulated in holes 402 in order to keep region 404 at low temperature. An insulation layer 403 is placed outside the vacuum bag 204 to prevent the heat from the oven to cure the surface of the multilayer membrane 401. After demolding, the multilayer membrane 401 will be cured in region 405 while partially cured in region 404. Another way to partially cure the multilayer membrane would be to apply pressure to region 405 only. Region 404 will be partially cured on demolding.

FIG. 5b shows an embodiment to manufacture a multilayer membrane 407 in the form of a closed bladder. A female mold 406 is used to retain the partially cured membrane 407 after molding according to FIG. 5a. In this particular embodiment, two multilayer membranes 401 are placed face to face with a joint line 408. An uncured rubber strip 409 is placed along the joint line 408 to prevent the multilayer membrane 407 from any air or liquid leak. An air pressure port 410 is provided to apply the required (positive) consolidation pressure during manufacture. The assembly is then heated following the cure cycle described in FIG. 3. During manufacturing, the uncured rubber strip 409 bonds to the surface of the partially cured membrane 407 (as shown in FIG. 5a), and seals the membrane bladder. Note that a sequential cure and pressure application in different zones is also possible to manufacture segmented membranes.

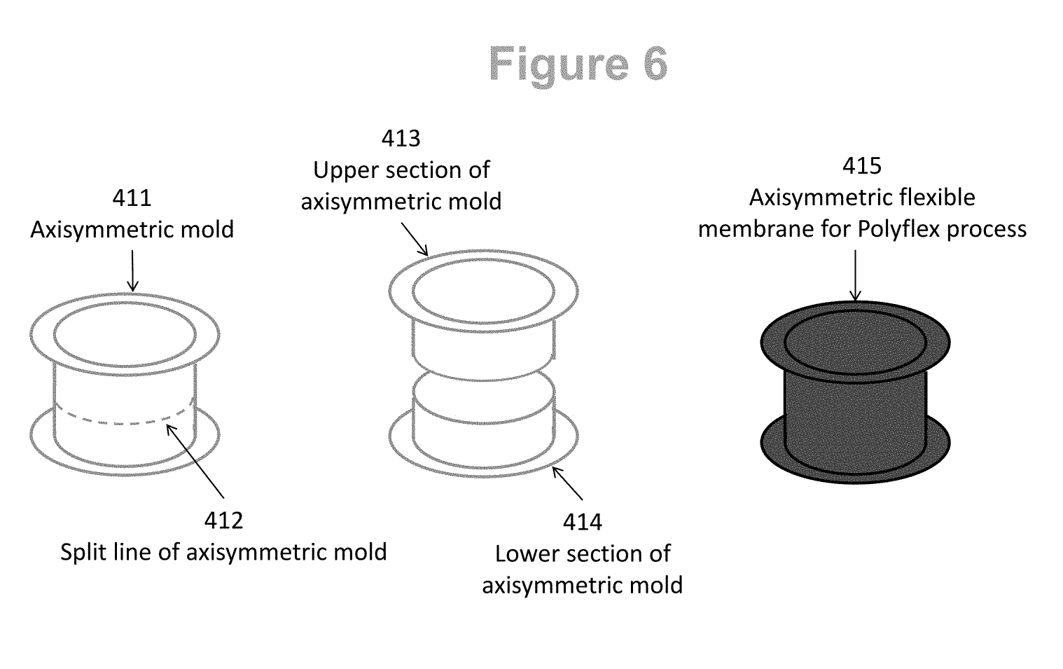

FIG. 6 shows an embodiment to manufacture a multilayer membrane 415 in the form of an axisymmetric bladder to be used in accordance with U.S. patent US20120217670A1 (i.e. Flexible Injection Process). An axisymmetric mold 411 is used to retain the un-cured multilayer membrane 210 according to FIG. 2. In this particular embodiment, the uncured rubber sheets 201 is placed on the surface of the axisymmetric mold 411 and reinforcing fibers 202 are placed between two or more partially cured rubber sheets 201 to form the axisymmetric membrane 415. A release film 203 is placed on top of the multilayer membrane 415. The vacuum bag 204 is sealed to the axisymmetric mold 411 by a sealing tape 205 placed on the periphery of the axisymmetric mold 411. A vacuum port 206 is provided on the axisymmetric mold 411 to pull vacuum between the vacuum bag 204 and the axisymmetric mold 411. The embodiment is then placed on an oven to follow the typical cure cycle of FIG. 3 to cure the axisymmetric multilayer membrane 415. The axisymmetric mold 411 can be split into two sections at the split line 412. After curing the axisymmetric multilayer membrane 415, the axisymmetric mold 411 is split in the upper section of the axisymmetric mold 413 and the lower section of the axisymmetric mold 414 allowing the axisymmetric multilayer membrane 415 to be demolded. In all of these molding processes, the durability of the flexible membrane is essential for productivity and geometrical consistence of the molded components. Manufacturing composite components for several industries such as aeronautics, space, sports, etc., requires the composite component to be cured at high temperature, often higher than 350 F. (180 C.). When demolding the composite component at high temperature, the flexible membrane may bond to the component during resin cure due to chemical compatibility between the membrane material and the polymer resin or to mechanical attachment to the membrane. A given pulling force is often required to detach the flexible membrane from the molded component, which induces a permanent deformation on the flexible membrane that modifies it geometry. After several molding components, the geometrical distortions of the flexible membrane no longer allow the use of the flexible membrane on the mold.

For these reasons, an improved semi-rigid three-dimensional membrane, as described above, is desired, and more in particular, a way to control the variable rigidity, thickness and surface finish of the membrane in order to ensure longer durability and geometrical stability of the semi-rigid membrane, and finally of the molded component. Multilayer three-dimensional composite membranes can be advantageously used not only in composites manufacturing, but also in several other areas such as flow rate control, compression filters, etc.

1. A multilayer membrane for use in molding processes, the membrane comprising:
at least one flexible layer;
a plurality of fibrous reinforcement components; and
an external layer.

2. The membrane of claim 1, wherein the external layer is a non-adherent plastic film.

3. The membrane of claim 1, further comprising:
one or more metallic components.

4. The membrane of claim 3, wherein the one or more metallic components are sheets and/or wires embedded within the multilayer membrane, co-cured to or glued on its exterior surfaces.

5. The membrane of claim 1, wherein the external layer is a metallic coating.

6. The membrane of claim 2, wherein the non-adherent layer is a porous plastic film impregnated with a material forming the at least one flexible layer.

7. The membrane of claim 2, wherein the porous plastic is provided with non-adhesive properties such as polytetrafluoroethylene plastics.

8. The membrane of claim 1, wherein the plurality of fibrous reinforcement components is sandwiched between at least a first and a second flexible layer.

9. The membrane of claim 1, wherein the membrane has a three-dimensional configuration.

10. The membrane of claim 1, wherein the membrane has a first multi-layer configuration in a first region and a second, different, multi-layer configuration in a second region.

11. The membrane of claim 1, wherein the membrane has a first rigidity in a first region and a second, different, rigidity in a second region.

12. The membrane of claim 1, wherein the membrane includes localized stiffened regions.

13. A process to mold a multilayer membrane, comprising:
providing at least one polymer layer;
providing a reinforcement fiber layer;
providing one of a non-adherent plastic film, a metal sheet, or metal coating layer;
placing the provided layers on a mold providing the geometry of the ultimate component to be molded.

14. The process of claim 13, wherein part of the multilayer membrane is provided as a partially cured layer.

15. The process of claim 13, wherein the polymer layer is provided as a rubber layer.

16. The process of claim 13, wherein the reinforcement fiber layer is provided as dry reinforcement fibers.

17. The process of claim 13, wherein the reinforcement fiber layer is provided as a prepreg comprising a reinforcing fiber as described in claim 16 pre-impregnated with a noncured rubber layer as described in claim 15.

18. The process of claim 13, wherein the multilayer membrane is manufactured in the form of a closed bladder.

19. The process of claim 13, wherein the multilayer membrane is manufactured in an asymmetrical shape to be used in accordance with U.S. patent US20120217670A1.
